(19) United States
(12) Patent Application Publication
(10) Pub. No.: US 2023/0236546 A1
(43) Pub. Date: Jul. 27, 2023

(54) ILLUMINATION POWER CONTROL FOR A COMPUTER-GENERATED HOLOGRAM DISPLAY

(71) Applicant: VividQ Limited, London (GB)

(72) Inventors: Thomas James DURRANT, London (GB); Sapumal Jaliya SENANAYAKE, London (GB); Julian GOLD, London (GB); Alden Oliver SPIESS, London (GB); Darran Francis MILNE, London (GB); Christian Timothy FIELDHOUSE, London (GB); Indi PRITCHARD, London (GB); Roman Wolfgang PECHHACKER, London (GB); Omer Arda TASTEMUR, London (GB); Andrzej KACZOROWSKI, London (GB)

(21) Appl. No.: 18/192,118

(22) Filed: Mar. 29, 2023

Related U.S. Application Data
(63) Continuation of application No. PCT/GB2021/052566, filed on Oct. 5, 2021.

(30) Foreign Application Priority Data
Oct. 6, 2020 (GB) 2015789.7

(51) Int. Cl. G03H 1/22; G03H 1/02; G03H 1/08

(52) U.S. Cl. CPC G03H 1/2294; G03H 1/02; G03H 1/0808; G03H 2001/0212; G03H 2240/51

(57) ABSTRACT

A method for adjusting the apparent brightness of a computer-generated hologram display is disclosed. The method comprises: receiving source data representative of a scene to be displayed as a hologram; determining hologram data to display a computer-generated hologram representing the scene; determining a scene energy based on the source data, the scene energy being quantised using a scale which is non-linear and which has a closer spacing between values in a mid-section of the scale than between values towards a minimum and a maximum of the scale; associating the scene energy with the hologram data; controlling a holographic display according to the hologram data and simultaneously controlling an output power of an illumination source of the holographic display according to the scene energy. A holographic display apparatus implementing the method is also disclosed.

### CROSS-REFERENCE TO RELATED APPLICATIONS

This application is a continuation under 35 U.S.C. § 120 of International Application No. PCT/GB2021/052566, filed Oct. 5, 2021, which claims priority to GB Application No. GB 2015789.7, filed Oct. 6, 2020, under 35 U.S.C. § 119(a). Each of the above-referenced patent applications is incorporated by reference in its entirety.

### BACKGROUND

### Technical Field

The present invention relates to methods and apparatus for controlling the illumination power of a Computer-Generated Hologram (CGH) display.

### Background

A computer-generated holographic image is produced when at least partially coherent light is incident on a display device capable of modulating the wavefront of incident light in such a way as to create an interference pattern that sums to yield an image to an observer looking directly or indirectly into the display. The pattern displayed on the device is referred to as the hologram. The hologram, through modulating the amplitude, phase or a combination of both, steers the incident light into a replay field to create an image.

A characteristic of such a CGH image is that the total power of light is conserved in the output. As a result, objects that appear large in the replay field of the hologram will appear dimmer than objects that appear smaller, for the same power of light incident on the display. Therefore, for the same illumination power, holographic images of varying sizes will have different brightness. This can reduce image quality, reduce the overall viewing experience, lead to incorrect reproduction of colours and/or potentially create a dangerously high brightness (such as if the entire laser power is focused on a single spot).

It would be desirable for a CGH to have more consistent apparent brightness between images of different sizes in the replay field.

### SUMMARY

Embodiments of the present invention make use of an energy or intensity calculation at a frame or sub-frame level to adjust an optical power of an illumination source of a computer-generated hologram display such that the apparent brightness of a replay image is consistent with the brightness of an original scene used for the CGH. Other embodiments provide ways for such energy or intensity to be communicated between elements of a holographic display system in a way such as to maintain synchronisation between the illumination power and the displayed CGH.

While backlight power control has been proposed for some display technologies, such as Liquid Crystal Displays (LCDs), this focuses on expanding an apparent dynamic range of the display; expanding the contrast ratio or the perceived difference between light and dark sections of an image. An LCD operates by blocking the backlight to some degree so that illumination from the backlight is not conserved in the output. When backlight dimming is used with an LCD, the light required to be blocked for dark pixel is reduced, so dark colours appear darker. However, the total power of illumination is not conserved in the way it is with CGH displays. Unlike backlight dimming for contrast enhancement, the embodiments herein control energy for more consistent brightness across different displayed CGH images. In addition, when images are displayed on non-holographic displays, such as LCDs, the image data sent to the display includes scene energy (brightness) information, so that the frame data itself can be used to determine a required brightness. In contrast, a holographic replay field does not inherently include scene energy information; this is lost in the conversion to the hologram, so it is advantageous to determine a scene energy from the source data.

According to a first aspect of the present invention, there is provided a method for adjusting the apparent brightness of a computer-generated hologram display. The method comprises: receiving source data representative of a scene to be displayed as a hologram; determining hologram data to display a computer-generated hologram representing the scene; determining a scene energy based on the source data; associating the scene energy with the hologram data; and controlling a holographic display according to the hologram data and simultaneously controlling an output power of an illumination source of the holographic display according to the scene energy.

Source data may be any suitable data for generating a hologram for display, such as a 3-dimensional array including intensity and/or colour data with an associated depth or position in a reference space, or a collection of points in 3-dimensional space with associated intensity and/or colour data (such as point-cloud data). For example, the source data may be output from a graphics engine, such as the Unity® 3-dimensional engine. Determining hologram data from source data is known to the person skilled in the art. However, when such hologram data is displayed, the apparent brightness of the scene will depend on the occupancy of the replay field. If only a small part of the replay field is occupied with the scene, the scene will appear brighter than if a large part of the replay field is occupied with the scene, for the same output power of the illumination source. The variation in perceived brightness is addressed by determining and using scene energy in the display of the hologram.

Scene energy may also be referred to as illumination energy or intensity. The scene energy is determined based on the source data and so considers the brightness of the source data to be represented by the hologram. The scene energy can be determined at a frame level or a sub-frame level. A sub-frame may be a single colour for display with others to generate a perceived full colour image, such as a red, green and blue sub-frame. One example to determine scene energy is to sum the colour and/or intensity values of all pixels in the bitmap of source data at the frame or sub-frame level.

By associating the scene energy with the hologram data, it can be maintained in substantial synchrony with the hologram data, allowing the illumination source to be controlled to vary its power as each frame or sub-frame is displayed.

The association between the scene energy and hologram data can be formed in various ways, for example using metadata associated with the hologram data, or by providing the scene energy in a header section of the hologram data.

The scene energy may have a very large range of values. The range will scale with the number of pixels, increasing the more pixels there are. In some examples, the scene energy is normalised to a scale between a predetermined minimum apparent brightness and a predetermined maximum apparent brightness. For example, the scene energy may be normalised between 0 and 1, and the scene energy normalised by dividing by the scene energy value for a completely white image. Other factors can also be considered in the normalisation, including one or more of a maximum scene energy for safe viewing of the hologram, a maximum possible output power or intensity of the illumination source, and a minimum energy detectable by human eye in specified conditions.

The many different values for scene energy may mean that it is technically challenging to construct a display system that is both eye-safe (the output power does not exceed that permitted for a Class 1 device under BS EN 60825-1:2014) and able to produce a visually distinguishable change for each small change in scene energy. A holographic display with acceptable quality may be achieved by quantising the scene energy to a smaller range of discrete values falling within the range of visually distinguishable illumination powers that the display equipment can produce. For example, the scene energy might be quantised to an 8-bit or 16-bit number. The scene energy may therefore be quantised on a predetermined scale to reduce the number of different brightness values. While some examples may use a linear scale, other examples may quantise the scene energy on a non-linear scale. A non-linear scale can provide smaller differences between values where the human eye is most sensitive to variations in brightness, or can ensure that there are more visually distinguishable brightness levels for the most common scene energy levels, improving perceived image quality while reducing the number of values required to quantise scene energy. For example, a logarithmic quantisation may be used.

In examples using a non-linear scale for quantisation, the non-linear scale may have a closer spacing between values in a mid-section of the scale then it does between values closer to a minimum and a maximum of the scale. For example, the spacing could use a logarithmic spacing but, rather than distributing the points so that they are closest spaced towards the minimum or the maximum, they can be distributed so that they are closest spaced at a mid-point and with spacing increasing towards both the maximum and minimum. The mid-section may be centred on the halfway point between maximum and minimum, or offset from the halfway point.

As discussed above, the scene energy may be a sum across all pixels and colours in the source data. In that case, the sum may comprise a respective weighting for each colour in the source data. The weighting can account for various different factors, such as one or both of different hardware characteristics when reproducing each colour and different perceived brightness for each colour in the human eye.

The scene energy may also be represented by sums across all pixels for each colour in the source data, each colour corresponding to a colour of the illumination source. This can be useful when colour is displayed by time-multiplexing different colours of illumination source, such as red, green and blue illumination sources.

In some examples, the method comprises monitoring an emitted intensity of the illumination source and using the emitted intensity for feedback control of the output power of the illumination source. This can remove the need to calibrate an output brightness to the scene energy: by monitoring the brightness (such as by using a photodiode or photosensor) feedback control can be used to match the emitted brightness to that indicated by the scene energy. There may also be benefits to feedback control to compensate for changes in the output characteristics of an illumination source during its operation. For example, the output intensity may change as the illumination source ages and/or change with the operating temperature of the illumination source.

Some examples may include monitoring an emitted intensity of the illumination source and shutting off the illumination source if the emitted intensity exceeds a predetermined threshold. This may improve the safety of the system. Some examples may combine this shut off with the feedback control discussed above.

The output power of the illumination source can be controlled in any suitable way. In general, the output power depends on one or more input drive parameters. Example input drive parameters include drive current and pulse width. In one example, controlling the output power of the illumination source uses a combination of current modulation and pulse width modulation (PWM). For example, the output power to the illumination source can be varied both changing an absolute value (through the current modulation) and changing an average value (through PWM). PWM may be expressed in terms of pulse width or duty ratio. The current modulation and PWM can be combined in various ways. One example uses current modulation with constant pulse width above a predetermined threshold and PWM with constant current below the predetermined threshold, or vice versa. Other examples may vary both PWM and current simultaneously. Where there is a switch between PWM and current modulation either side of a predetermined threshold, the total number of levels to control the illumination source intensity may be the sum of the number of levels used for current modulation and the number of levels used for PWM. By varying both current and PWM together, a greater number of levels is possible (the product rather than the sum) but determining the current and PWM level to use may be more complicated.

Some examples may receive data indicative of a temperature of the illumination source. That data can then be used in the controlling the output power of the illumination source, so that the output power is based on the data indicative of the temperature of the illumination source and the scene energy. This can improve the accuracy of the output power of the illumination source. The output power of the laser diode may be dependent on temperature as well as input drive parameters, as mentioned above. By receiving data of the current temperature, the data can be used in the control, such as via a predetermined lookup table or previous calibration of the illumination source. Some examples may combine this data indicative of temperature with the feedback control of monitored output intensity discussed above. This may improve response times for the feedback control to achieve the required output intensity. Other examples may use the data indicative of temperature in isolation of such feedback control. This can allow a simpler construction because temperature data may be collected without impinging the optical path.

In examples, controlling the holographic display according to the hologram data and simultaneously controlling the output power of an illumination source is synchronised based on a signal received from a modulator of the holographic display. A modulator of the holographic display may have a different response time to the illumination source, typically the modulator is slower. By synchronising based on a signal received from the modulator, for example a signal indicating that the modulator has formed an image ready for display, perceived image quality can be improved.

According to a second aspect of the invention, there is provided a holographic display system. The system comprises: an at least partially coherent illumination source; a modulator configured to be illuminated by the illumination source; an input for receiving source data; and a controller configured to operate according to the method of the above-described first aspects, with or without the optional features also described.

The illumination source may be substantially coherent in some examples. Example illumination sources include a laser and a Superluminescent Light-Emitting Diode (SLED). Example modulators include a Spatial light modulator (SLM). The input can receive source data in any suitable way including a wired or wireless connection using existing protocols for transmission of display data, network data and/or serial data. Any combination of software and hardware can be used to implement the controller, for example the controller may be an Application Specific Integrated Circuit (ASIC) or Field Programmable Gate Array (FPGA) configured to execute the processing in hardware, or a processing system, such as a microprocessor, graphics processing unit, or programmable Digital Signal Processor (DSP) programmed by computer program code to implement the processing.

According to a third aspect of the present invention, there is provided a method of operating a holographic display. The method comprises: receiving hologram data and associated scene energy data; operating a modulator to modulate a substantially coherent illumination source, thereby to generate a light field corresponding to a frame or sub-frame of the hologram data; and controlling an output optical power of the illumination source incident on the modulator according to a scene energy associated with the frame or sub-frame of hologram data. In this way the perceived brightness of the hologram can be controlled according to the scene energy data. The scene energy data may be determined by another element than the display itself, for example sent from a processing system that is providing hologram data to the holographic display. The controlling of the output optical power may be synchronised based on a signal received from the modulator.

According to a fourth aspect of the invention, there is provided a holographic display apparatus. The holographic display comprises: a substantially coherent illumination source; a modulator configured to be illuminated by the illumination source; an input for receiving hologram data and scene energy data associated with the hologram data; and a controller configured to operate the modulator and the illumination source according to the method of the third aspect. While the illumination source and modulator may be the same as in the second aspect, the controller of this aspect is configured to control display of holographic data without also determining that data and the associated scene energy. This can allow the holographic display to be simpler with lower processing requirements, which may allow lower power operation and improved miniaturisation or integration of components. As with the second aspect, the controller can be implemented as any combination of hardware and software.

According to a fifth aspect of the present invention, there is provided a method of generating computer-generated hologram data. The method comprises: receiving source data representative of a scene to be displayed as a hologram; determining hologram data to display a computer-generated hologram representing the scene; determining a scene energy based on the source data; and associating the scene energy with the hologram data. The scene energy is for controlling an output power of an illumination source when displaying the computer-generated hologram data. The method of this aspect may include any of the optional features of the first aspect discussed above. Unlike the first aspect, a holographic display is not directly controlled. This method could be useful where the display is separate from the encoding for display. Examples include a computing system, games console, image source or video source which generates hologram data for sending to a separate holographic display and/or for storage. Storing the hologram data and associated scene energy can be useful for pre-generating or pre-rendering content for later display, such as pre-rendered media for later reproduction, perhaps in a cinema or in a user's home.

According to a sixth aspect of the present invention, there is provided a method of transferring data to a holographic display. The method comprises: associating scene energy data with a frame or sub-frame of hologram data; and transferring the scene energy data simultaneously with the hologram data. The simultaneous transmission keeps the scene energy data synchronised with the hologram data. The scene energy data may be associated using metadata.

According to a seventh aspect, there is provided a processing system configured to implement the method of at least one of the fifth or sixth aspect. For example, the processing system may be a computing system, games console, image source or video source.

According to an eighth aspect, there is provided an illumination source driver apparatus. The apparatus comprises: an input for receiving scene energy data; a pulse width modulator; an adjustable current source; an output coupled to the pulse width modulator and the adjustable current source for outputting a signal to control an emission power of an illumination source; and a controller. The controller is configured to control a pulse width of the pulse width modulator and a current of the current source based on received scene energy data. The driver apparatus can be used to control the output level of a substantially coherent illumination source for a holographic display according to scene energy data.

The illumination source driver may comprise a sensor for sensing an emission power (or output power) of the illumination source; wherein the controller is configured to control the pulse width and current further based on the emission power. This may allow the driver to control the illumination source more accurately, using feedback control. Some examples may combine the sensing of emission power with control based on data indicative of temperature discussed above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagrammatic representation showing how holographic image brightness varies with the replay field.

FIG. 2 is a diagrammatic representation showing how illumination power is adjusted in an example for more consistent image brightness.

FIG. 3 is a flow diagram of a method for operating a holographic display system according to an example.

FIG. 4 is a diagrammatic representation of a quantisation method that can form part of the method of FIG. 3.

FIG. 5 is a diagrammatic representation of a split between PWM and current modulation control of illumination source power that can form part of the method of FIG. 3.

FIG. 6 is a block diagram of a holographic display system for implementing the method of FIG. 3.

FIG. 7 is a block diagram showing interactions between various parts of a holographic display system according to an embodiment.

FIG. 8 is a diagrammatic representation of a laser power control system that can form part of the holographic display system of FIG. 6 or 7.

FIG. 9 is a block diagram of hardware control for synchronising a displayed CGH with an appropriate illumination level.

### DETAILED DESCRIPTION

### Effect of Illumination Power on Perceived Brightness

Example holographic displays comprise a phase modulating Liquid Crystal on Silicon (LCoS) display, illuminated by a coherent or at least partially coherent source, such as a laser source. In this case, the display is a reflective type—the laser beam from the laser source is optically expanded to cover the whole surface of the display containing the hologram and the reflected light forms the holographic image.

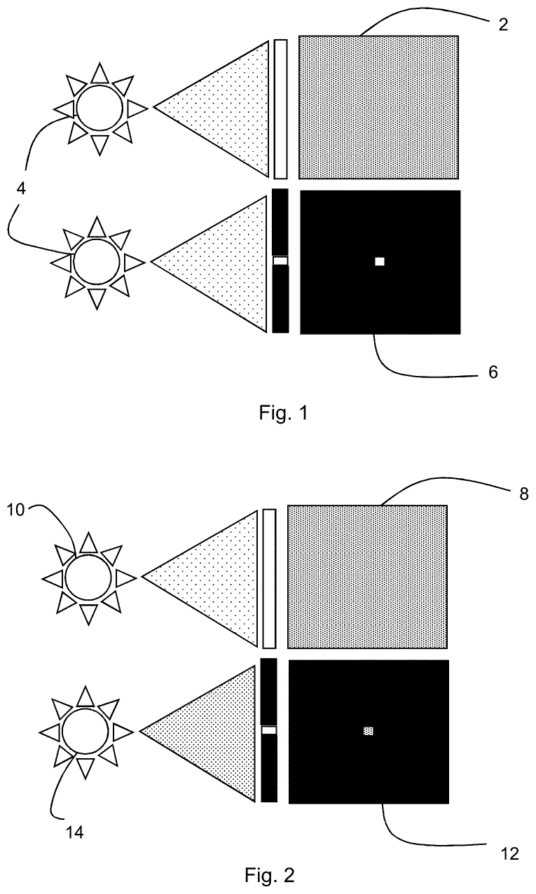

Unlike non-holographic displays, the light energy incident on a holographic display is conserved, up to inefficiencies in the display. That is, the energy of the light from the display surface that is diffracted to form the holographic image is substantially equal to the energy of light incident on the hologram. For images of different apparent size, this means that if the same illumination power is used for all images, then the same light power will be distributed into different volumes, with the result that larger holographic images appear dimmer than smaller holographic images. This effect is illustrated diagrammatically in FIG. 1.

FIG. 1 shows diagrammatically how a size of a hologram in a replay field impacts perceived brightness. The upper hologram 2 diffracts the light from an illumination source 4 into a square of constant intensity across the whole holographic replay field. The lower hologram 6 diffracts the light from the same illumination source 4, operating at the same power, into an area the size of a small square occupying 1% of the replay field. The smaller lower hologram 6 is significantly brighter than the upper hologram 2 because the same illumination energy is concentrated into a smaller area.

Unlike non-holographic displays, the brightness of the image therefore depends not only on the brightness or intensity of the illumination source but also on the size of the holographic image in the replay field. This impacts the perceived image quality because holographic images of different sizes will appear at different brightness from each other, even if they all had the same brightness in the source data used to generate the holographic image (such as a representation of a scene which is then rendered as a hologram). In some cases, the holographic images may be sufficiently large that their perceived brightness is so low that they become imperceptible against background ambient light, especially for augmented reality display systems. At the other extreme, a particularly small holographic image may result in an image which is bright enough to cause eye safety issues because the light intensity may exceed an eye safe limit.

Controlling Illumination Power for Consistent Brightness with Size of Image

To maintain constant brightness across varying source scenes, systems discussed herein adjust the illumination power according energy in the source data, for example by using the pixel occupancy and the intensity of the points in each given source scene. In this way, consistent brightness can be achieved between holograms of different sizes. This is illustrated in diagrammatic form in FIG. 2.

The upper hologram 8 of FIG. 2 corresponds to the upper hologram 2 of FIG. 1—it is a square filling the entire replay field. For this hologram, the illumination source 10 is operated at 100% output power. The lower hologram 12 corresponds to the lower hologram 6 of FIG. 1. As only 1% of the volume is occupied, the illumination source 14 is operated at 1% output power. The result is that the holograms 8 and 12 have the same apparent brightness and image quality is improved.

The discussion of FIGS. 1 and 2 above considers a monochrome hologram. For full colour hologram there may be multiple illumination sources (such as red, green and blue lasers) and the system may adjust the power for all illumination sources in sync with the display of images in that colour. For example, the colours may be time division multiplexed as different sub-frames, using persistence of vision to form a colour image. In that case the required illumination power can be considered for the scene as a whole (all sub-frames) or for individual sub frames.

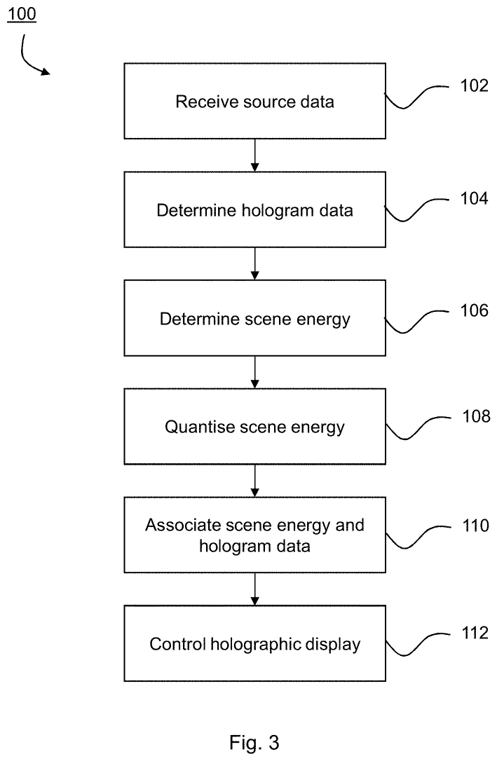

Having outlined the general principle of operation, an example method of operating a holographic display system which can adjust the power of an illumination source for more consistent holographic image brightness will be described. FIG. 3 is a flow diagram of a method 100 for operating a holographic display system according to an example. In this example, the method makes use of a single phase-modulating LCoS as a colour sequential display. Colour images are displayed by time division multiplexing an RGB laser source, with high switching speed, to illuminate the LCoS.

At block 102, source data is received. In this example, the source data is scene data received from Unity (a 3D content engine). “Receiving” data includes the source data being pushed from a content source or pulling the source data by requesting it from the content source.

Next, at block 104, the holographic data is determined. In this example, the Unity® scenes are provided as input into a software program that computes holograms from the scene data using methods known to the person skilled in the art. For example, a suitable algorithm to provide real-time hologram generation is discussed in “Adaptive Aberration Correction for Holographic Projectors”, Kaczorowski, A. available from https://www.repository.cam.ac.uldhandle/1810/270322 and in WO 2020/148251 A1.

At block 106, a scene energy is determined from the source data. A brightness and occupancy of the scene are extracted and used to determine the energy in the scene in the source data. For example, is the scene light or dark, and how much of the scene is occupied? In this block a number is determined for each hologram frame (or sub-frame in colour mode) that represents a desired illumination power to maintain a constant brightness for the image from the source data.

The scene energy may be used directly, however, in this example, the determined scene energy is quantized at block 108. Quantisation can provide several benefits. These include any or all of: reducing the resolution of the scene energy so it is easier to handle and process, ensuring that the scene energy corresponds to a value which can actually be output by a laser, and ensuring that that adjacent quantised scene energies result in a perceptible change in brightness (So that as the source scene occupancy and brightness changes, there is a corresponding visible change in illumination, and holographic ‘objects’ in the replay field seem to have consistent brightness).

The resulting quantised scene energy is then associated with the hologram data by adding it as metadata at block 110. The hologram data and laser metadata are then used to control the LCoS to display the holographic data while simultaneously controlling the power of the laser source using the scene energy metadata at block 112.

Control at block 112 can include hardware encoding, where the quantized scene energy values are encoded to into suitable values to drive the illumination sources to give the desired output power. This encoding may be performed by a dedicated hardware driver board that takes the input power values and converts to signals that can be interpreted by the illumination sources. There is no guarantee that the perceived image brightness is linear with the input power, so the hardware encoding may use a calibration to map quantised scene energies to specific input power values to control the illumination source.

In some examples, the control at block 112 includes receipt of data indicative of the temperature of the laser, for example from a temperature sensor integrated into the laser package or in contact with the package. Any suitable temperature sensor can be used, such as thermocouple. In this case, a plurality of calibration curves or look-up tables may be stored, each corresponding to a different laser temperature. A particular calibration curve or look-up table is selected based on the data indicative of temperature. The calibration curves or look-up tables may be determined from prior experimental testing of lasers of the same type, from data supplied by the manufacturer of the laser, and/or from a calibration of each laser as part of the manufacturing process.

In other examples, the control at block 112 may use predetermined data of laser output. As the laser is used its temperature will change, and so the output power will change over time for the same input. This temperature vs time relationship may be determined experimentally for a known input by measuring what happens to the temperature in the laser enclosure over time, such as by using a separate temperature probe. Display systems using the same model of laser will behave similarly, so the likely laser temperature of such can be determined by knowledge of the input and time of operation with that input. This can allow compensation for laser temperature without requiring a temperature sensor in the hardware, because the temperature is determined based on the input drive parameters and operation over time.

While the method of FIG. 3 has been described sequentially, some blocks may be executed in parallel (such as blocks 104 and 106) and the order of some blocks may be changed (for example block 104 can be moved to after block 108.

### Determining the Scene Energy

At block 106, the scene energy data may be determined by considering pixel occupancy and pixel intensity. Pixel occupancy is determined by how many pixels are occupied (not black) in the source scene. Pixel intensity is determined from the colour values of each pixel to give a measure of the colour intensity of each occupied pixel. When the source data is expressed as RGB data, black pixels have red, green and blue encoded as zero. The sum of energy across all of the RGB values can therefore be used to determine the scene energy according to equation (1) below:

$$E = {\sum }_{i} {\sum }_{j} {α}_{j} {c}_{ij}^{2} \qquad Equation ( 1 )$$

where i indexes the pixels in the source data and j={C₁, C₂, . . . , C_{N}} are the allowed colours. The {cᵢⱼ} are the j-th colour component of the i-th pixel. The coefficients, {αⱼ} are scaling constants that are dictated by the illumination source that will be generating each colour component in the holographic image. These coefficients are hardware specific and are determined based on the characteristics of the illumination sources used in a particular implementation. For example, the coefficients may be determined as a mean value for a particular model, part no. or SKU of illumination source from test data.

In one example, the coefficients {αⱼ} are determined experimentally. A reference current was chosen for each of the Red, Green and Blue lasers. A hologram was calculated of a reference scene that was a white square, and the coefficients were adjusted until the perceived square in the replay field appeared to be white. The adjustment could be based on observation by a human or by measurement using a colorimeter, such as a passive display colorimeter or similar. It is possible that the colour will vary over the replay field. Some examples may repeat this measurement for a white square in different positions on the replay field and take an average, such as a mean value, of the results at the different positions.

The result of equation (1) may then be normalised to a range between E=0 (all black, nothing displayed) and E=1 (all pixels are white).

To give a more specific example, the source data received from Unity may comprise rendered scenes stored in memory as RGBZ data or point-cloud data. Each element, or pixel, is encoded as 32-bit RGBZ data. 32-bit RGBZ data comprises an 8-bit Red value, an 8-bit Green value, an 8-bit Blue value and an 8-bit depth value. For the purposes of the brightness control, the 8-bits of depth data are discarded to leave a 24-bit colour map that will be referred to as the source frame. Other examples can use different bit depths for the RGBZ data.

To apply equation (1), it is assumed that Unity renders the source frames at a resolution of M×N. This gives the total number of pixels over which the index i runs. For this implementation, there are red, green and blue laser sources and j is fixed to be in {0=Red, 1=Green, 2=Blue}. The calculated energy for each source frame is stored as metadata alongside the hologram computed from that source frame.

In another example, rather than summing the energy across all RGB values, the energy can be calculated for each component using equation 1a below:

$${E}_{j} = {\sum }_{i} {α}_{j} {c}_{ij}^{2} \qquad Equation ( 1 a )$$

This may be preferable when colour is reproduced by time-multiplexing individual colour components. The terms of the equation are the same as discussed. The energy can therefore vary by colour component rather than being set at the same value for all components.

In further examples, rather than using a square term as in equations 1 and 1a above, energy can be calculated in any suitable way, depending on the hardware and the source data used for display. For example, the calculation of the energy may incorporate a target gamma value of the display hardware, or otherwise account for gamma, such as by using predetermined data of the gamma.

### Quantization of Energy Values

More examples of the quantisation at block 108 will now be described. The calculated energy for a source frame, rendered to a typical displayed resolution can take many possible values. For a display of resolution M×N and colour bit depth k, the highest possible energy value is given by:

Highest possible energy value=M×N×2^{2k} Equation (2)

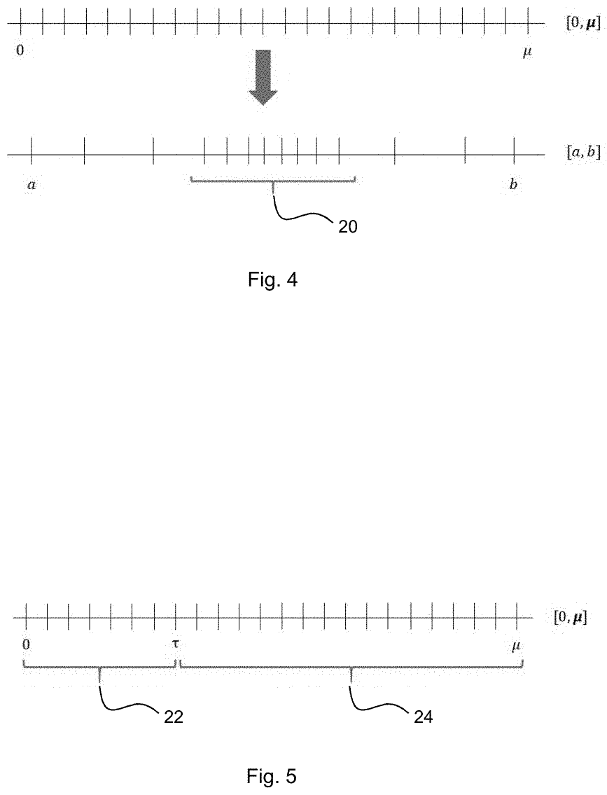

In fact, the true value used is M×N×(2^{k}−1)², because zero (black) is included in the 2^{k} levels, but an approximation is made in (2) to make the equations in this discussion simpler. Thus, because the energy values are integers, there are also at most this many distinct energy values. For a high-resolution display with a large colour range, the number of possible energy values can become very large and can exceed the number of possible illumination levels that are available from the light source. The energy value is therefore quantised by defining a map, from the energy values to the allowed illumination source power values, [E₁, E₂, . . . , E_{M×N×2}_{^{2k}}]→N[0,μ], in the following way:
1. An energy value of 0 should correspond to an illumination power of 0, giving a black output.
2. The maximum energy value should map to the highest allowed illumination power, μ. However, this maximum illumination power is preferably lower than or equal to an eye-safe limit (the maximum power which can be viewed by a human eye safely).
3. Non-linearities in the illumination source output may result in small scene energy values failing to produce sufficient output power from the illumination source to provide any illumination. To account for this the energies map from the range [E₁, E₂, . . . , E_{M×N×2}_{^{2k}}] to an integer range [a, b], where a∈[0, μ] is the lowest possible illumination power that produces a non-zero output and b∈[a+1, μ] is the maximum allowed illumination output power.
4. In addition, not all values for E are of interest. For example, it is highly unlikely that the output will be a single very dim pixel or a large white box, so the quantized values can be scaled to congregate around the range of values that are most likely to be used in a real scene. In other words, the quantisation can have smaller increments around the values most likely to be encountered. This can be done by applying a scaling function over the range to pack a majority of quantized values into the range of useful illumination states. This may improve perceived image quality when there are more desired values for E than there are available quantized values (for example where more values of E can be detected by the human eye than are available for quantising).
5. The remaining energy values are then quantized to the nearest allowed illumination power value on the scaling function, within the range [a, b]. These values are chosen such that the difference between an illumination power, p∈[a, b], is visually distinguishable from neighbouring powers, p−1 and p+1. This is depicted graphically in FIG. 4, showing how an identical spacing in the quantisation is compacted in a mid-section 20 and expanded away from the mid-section 20 using the scaling function.

The values a and b depend on the wavelengths of the light from the illumination sources, the physical properties of the illumination device, and the response characteristics of the display (LCoS in this case). Physical properties of the illumination device include a temperature response and inefficiencies from prolonged use. Due to this a and b values may be different for each illumination source in the display system.

A worked example of the quantisation will now be given. As discussed above, a Unity scene at a resolution of 1920×1080 with an RGB colour depth of 8-bits per pixel is supplied as the source frame. From equation (2), this yields approximately 2²⁹ possible energy values.

In this example, a phase modulating LCoS with resolution 1920×1080 is illuminated by RGB lasers. The laser control system accepts illumination information consisting of 2⁹=512 distinct current modulation values and an additional 2⁹=512 pulse width modulation values.

In an augmented reality (AR) display, the number of target levels to address in the quantisation can be further reduced by considering an average pixel occupancy of an AR scene. AR scenes are typically sparse, for example it may be assumed that only around 10% of the source frame pixels are occupied. The quantisation can therefore consider expected occupancy of the source data. In this AR example, the number of required energy levels is then at most (1920×1080×2¹⁶)/10≈13.6 Billion.

In this example, a linear mapping is used as follows.

1. The maximum energy that can be achieved is calculated

Max=1920×1080×2⁸×2⁸/10 (as described above), this is set as b with a as zero.

2. The total energy for each sub-frame is found as, E=Σᵢ cᵢ², for pixel intensities cᵢ.

3. The scaled energy is then E_{scaled}=E/Max.

Note that if the occupancy assumption is broken (the occupancy is greater than the maximum assumed, 10% in this case) then E_{scaled}>1. Should this occur, the value of E is clipped to 1. To accurately display content with higher occupancy than 10%, the factor of 10 in the definition of Max should be reduced. This ensures the values are within the allowed range of laser powers available.

### Hardware Encoding of Illumination Power Values

The illumination source may be driven by a driver circuit that takes as input the quantized illumination power levels and outputs a signal that sets the illumination source to emit light at the desired brightness. In this example the driver circuit outputs a signal which can be current modulated and/or pulse width modulated (PWM). With current modulation, the driver circuit sets the current to the illumination source, the power into the illumination source is proportional to the current and hence the output illumination power is also proportional to the current (the relationship may not be linear). With PWM, a voltage level input to the illumination source is predefined but the time the input is turned on is varied to vary the average input to the illumination source, again influencing the power in and hence the power output from the illumination source.

In this example, both PWM and current modulation are used, which may achieve consistent results across the range of input energy values. Note that the illumination source output power does not necessarily scale linearly with the energy value and so, for example, doubling the source energy value may not be equivalent to a doubling of the optical power. In that case, the non-linearity can be compensated by mapping the quantized scene energy values to the current and pulse length sent to the illumination sources.

The driver operates under one or more of the following constraints:

1. An input level of zero returns an output light power of zero.

2. A non-zero input level results in sufficient input power for a visible image in the hologram replay field.

3. For any input level, the output light power should not exceed the eye-safe limit.

4. In full colour operation, the driver balances the output power of the component illumination sources (red, green and blue) such that the output of all sources at full power is perceived to be pure white.

5. Each quantised level of the scene energy corresponds to visually distinguishable states.

### Calculation of Current Value and Pulse Duration

An illumination source has a range of possible brightness it can produce in combination with a control circuit, based on input drive parameters such as a range of pulse lengths and current values. The pulse lengths are limited by the stabilisation time of the control circuit at the low end, and the framerate and stabilisation time of the Spatial Light Modulator (SLM) pixels at the high end.

In some examples, the scene energy is encoded as a combination of a current and PWM values to drive the illumination source. This expresses the scene energy in terms of driving parameters for the illumination source. No further conversion is necessary for display. When scene energy is encoded in this way and associated with hologram data, it can be used to set the power of an illumination source with good synchronisation with the display of the holographic data because no additional processing is required. Put another way, the scene energy may be encoded as values specific to a particular illumination source rather than in a more general format such as a scene energy which requires processing to derive the parameters to drive the illumination source.

When the hologram data is produced, this metadata is attached and then passed to an illumination source driver at the point the hologram is displayed. This driver ensures that the metadata will be used substantially immediately to drive the sources and avoid frame lags and maintain synchronicity between the target illumination and the hologram frame (or sub-frame in full colour operation).

While it is preferable to send the metadata to the illumination driver directly from the display driver, it is also possible to extract the metadata and send separately to the illumination driver. In that case a separate system to maintain synchronization between the displayed frame and the illumination can be provided.

### Cyclic Redundancy Checks

For every frame (sub-frame in colour mode) the illumination driver performs a Cyclic Redundancy check (CRC) on the encoded scene energy data to ensure that valid data has been passed to the driver. If a CRC is failed or if data processing takes longer than a predefined threshold time, the illumination source is switched to the off state for that frame. This ensures that only valid signals trigger the illumination sources and so the output power cannot exceed the eye-safe limit.

### Laser Driver Metadata

FIG. 5 is a diagrammatic representation of a split between PWM and current modulation control of illumination source power that can form part of the method of FIG. 3. The derivation of this split will now be discussed.

In this example, current modulation and PWM are used for different ranges of control values, with PWM being used for values in a range 22 which is less than a predetermined threshold, τ, and current modulation being used for values in a range 24, greater than the predetermined threshold up to the predetermined maximum, μ.

For each source frame, the scene energy, E, is calculated as discussed above and a ratio, Λ, of source frame energy E to max energy μdetermined. If the ratio, A, is above the threshold value, τ, then the pulse width for PWM modulation is set to the maximum value and the current modulation is used to give the input power to the illumination source. If the ratio, Λ, is less than or equal to τ, then the current is set to a predetermined value and PWM is used. The predetermined value for current in PWM is chosen such that a minimum pulse width gives the required minimum visible output, and the maximum pulse width gives the threshold energy τ.

In one example, the value oft and the current for the PWM phase of control are determined empirically by first setting the PWM to a minimum value and then adjusting the current until a minimum brightness is achieved. This sets the value of the current for the PWM phase. Next, i is determined by using the determined current value and setting PWM to the maximum. In one implementation, the minimum value for PWM is zero, and the minimum current is set to be a value just above the lasing limit for the laser diode used. The minimum current can be experimentally determined or derived from the laser diode manufacturer datasheets. Typically, laser behaviour is non-linear and sensitive to temperature fluctuations and other factors close to the lasing limit so, in another implementation, rather than choosing the lowest observed current at which the laser diode beings to lase, a greater value of current is selected, for example a value at the bottom of a substantially linear area of laser response.

In some examples, the current modulation and PWM phases are inverted, so that the current modulation is used below the predetermined threshold and above the predetermined threshold PWM is used. Further examples may vary both the current modulation and PWM simultaneously over the whole or part of the control range.

It is possible that the illumination source may not have a linear response to the input power so that a scene energy is mapped to output powers to achieve the desired brightness. The mapping can compensate for or calibrate any non-linearity of the input source. One way to derive the mapping is as follows:
1. For each input energy value to the source, measure the output brightness with a light sensor. This provides the map from input to brightness for the given source and optical system.
2. To calibrate the system, for each input energy match up values sent to the source that ensure that the output powers are equally spaced in measured brightness. This new mapping of input energy to the signal sent to the source removes the non-linear response of the source and ensures the powers correspond to measurable differences in brightness.
3. The mapping reference function from input energies to current values giving equally spaced brightness, may then be passed back in a configuration file, for use by the encoder when encoding the scene energy. The reference function may also be stored and used as a predetermined calibration function for other devices using the same illumination source or illumination source and optical system combination.

In some examples the value of ti can be chosen so that current modulation is used for a portion where the relationship between input and output power is linear and PWM is used for a portion where the relationship between input power and output power is non-linear. (Non-linear operation is typically the case in the lower ranges of output power). In that case the parameters for the control are found as follows:
1. Define the sub-ranges of laser power values [0, μ] that employ current modulation and those that employ pulse width modulation by finding the value that yields the maximum brightness. This is performed empirically through direct measurement of the display.
2. Derive the calibration function to map the input source energies to equally spaced output power values. Here this involves picking a number of values then calibrate such that those values give equally spaced output powers. This assumes the values in between will be linear interpolated between the calibrated points. Using 5 values has been observed to give sufficient results, it will be appreciated that other numbers of values can also be used.
3. Define the minimum pulse width. In this implementation this is set to be approximately 2 μs. Define the maximum pulse length, which may be significantly less than the duration of the colour-subframe owing to the time needed for the liquid crystals in the SLM to stabilise on the correct phase offset. In this case approximately 120 μs is used (chosen to cover the period in which the values shown on the display are approximately correct). Both maximum and minimum values may be different for the different colour lasers.
4. For each frame, calculate the ratio of its energy to the max energy to give Λ. Compare this to the threshold value τ. In this case set such that ττ0.1.
5. For frames with Λ≥τ, set the pulse width to its maximum value (˜120 μs) and modulate the current. Calculate the required current value for each hologram frame from the interpolated calibration curve.
6. For frames where Λ≤τ, set the current to a predetermined low value. (For example, this may be predetermined empirically, such as a current value just above the lasing limit as discussed above) and modulate the pulse width. Calculate the pulse width for each hologram frame from the interpolated calibration curve.
7. A hardware settling period is considered. For example, a Liquid Crystal (LC) layer of each pixel in the display takes a non-zero time to switch between states and settle into the final configuration for a given sub-frame. Therefore, a time delay, Δt>0 is defined to delay the activation of the lasers until the LC has settled. This time delay is determined empirically and will depend on the type of LC and the driving electronics of the LCoS display. This step improves contrast of the final image by reduced influence of extra noise due to random fluctuations in the LC in the initial settling period. It will be appreciated that a hardware settling period may apply to other display technologies than LCOS.

### Encoded Scene Energy Data Structure

Once the current modulation and PWM values have been determined, they are encoded in a data structure consisting of 3 bytes (24 bit) as follows
9-bits (0-511) for the pulse width. In this example, the value is equal to the pulse width in μs. Other examples may encode the pulse width as a duty ratio, where 511=100%.
9-bits (0-511) for the current modulation level.
2-bits specify the colour the modulation will be applied to, for example 00=Red, 01=Green and 10=Blue. This allows different power for each sub-frame (colour) so that they can each have an associated modulation level (otherwise using the same modulation level for all colours would lead to an image with incorrect colour balance).
4-bits for the CRC check

These are all packed into the first 24-bits of a 32-bit int which is then packed into the header of the hologram data object.

Holographic Display System with Illumination Source Power Control

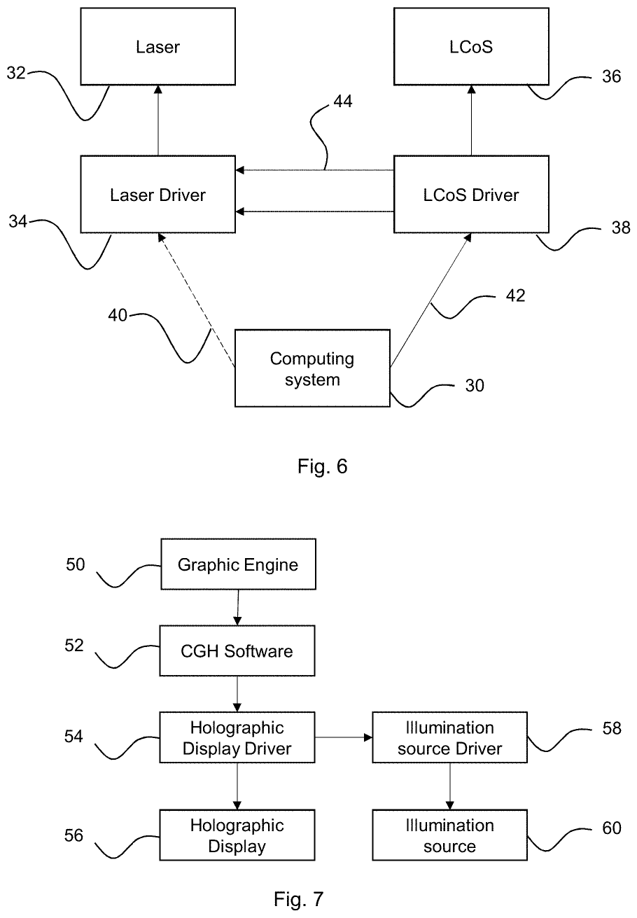

An example system in which the methods and data structures described above can be implemented is depicted as a block diagram in FIG. 6. The system comprises a computing system 30, a laser 32, a laser driver 34 for setting an illumination power of the laser 32, an LCoS 36 for modulating the laser 32 to provide a holographic replay field and an LCoS Driver 38 for driving the LCoS.

The configuration for the laser driver 34 is determined from the physical characteristics of the lasers and the LCoS display. At initialization, these parameters may be sent to the laser driver board from the computing system 30, for example over a USB link 40. Alternatively, the parameters may be predetermined and stored in firmware because they may remain the same for the lifetime of the display.

In operation, the computing system 30 calculates the holograms and associated laser driver or source energy metadata from received source data. The calculated hologram data and scene energy data is passed to the LCoS driver 38, for example using an HDMI or DisplayPort link 42. Next, the hologram is pushed to the LCoS display 36 while the laser metadata is sent to the laser driver 34, for example over an I2C bus, or serial link 44. The laser metadata determines the current and the pulse length used to drive the laser 32 and hence the output power. Synchronisation data is also exchanged between the LCoS driver and Laser Driver over link 46. For example, the synchronisation data can be a SYNC signal sent by the LCoS driver as a master device to the laser driver 34 as a slave device. The laser driver ensures that the lasers are activated in sync with the corresponding hologram frames on the LCoS display using the synchronisation data.

The data flow for the operation of the system may be as follows:
1. Initial setup via link 40 from computing system 30 to the Laser Driver 34, for example to exchange calibration data.
2. At the start of the display process, the computing system 30 calculates a hologram subframe and associated laser metadata.
3. The hologram data and the laser metadata for each subframe are encoded into a single frame buffer and pushed to the LCoS driver 38 (Display driver) over a display port connection on link 42.
4. The LCoS driver 38 decodes the framebuffer, transfers the hologram data to the LCoS display 36 and transfers the laser metadata to the laser driver 34 synchronously over link 44. The laser driver 34 is configured to ensure that the laser pulses (output of the illumination source, a laser 32 in this case) are synchronized with the corresponding hologram frame (up to the predefined time delay Δt) to give the correct corresponding illumination.
5. The process repeats for each sub frame to give a full colour holographic image.

By determining and applying the source energy metadata the system of FIG. 6 can display holographic images with more consistent apparent brightness.

In an alternative example system, the system of FIG. 6 is modified so that rather than the LCoS Driver 38 providing the laser power metadata to the laser driver 34, it is provided by an additional processor or processing system. The additional processor is provided inline between the computing system 30 and the LCoS Driver 38 (on link 42). The additional processor intercepts the output from the computing system 30, extracts the laser power metadata, provides the laser power metadata the Laser Driver 34, and forwards the rest of the information to the LCoS Driver 38. In this case the link 44 between the LCoS Driver 38 and the Laser Driver 34 is not required for laser metadata transfer and can be omitted or used for synchronisation between the LCoS Driver 38 and Laser Driver 34, such as signalling which subframe the LCoS is on and when it is ready for illumination.

In other examples, display technologies other than LCoS are used, for example a spatial light modulator (SLM). Likewise, other connection protocols can be used instead of I2C, such as Serial Peripheral Interface (SPI). The constructions and principles of FIG. 6 also apply to these examples,

FIG. 7 is a block diagram of another example holographic display system. A graphic engine 50, which is Unity in this example provides images as textures encoded as RGBZ data. The RGBZ data is pushed to a program 52 that computes a Computer-Generated Hologram (CGH) and the desired intensity for encoding as laser metadata from the Unity scene. This data is then passed to a holographic display driver 54 which uses it to drive a holographic display 56. Meanwhile, the scene energy metadata is sent from the holographic display driver 54 to an illumination source driver 58 that interprets the values and converts them to signals to drive an illumination source 60. The holographic display driver 54 is a Field Programmable Gate Array (FPGA) in this example, but it is not limited to this. Other examples may use an Application Specific Integrated Circuit (ASIC) or an appropriately programmed processing system.

While FIG. 7 depicts particular functional blocks, these blocks can be combined in some examples and/or implemented within a single processing system. For example, the holographic display driver and the illumination source driver can be combined as a single element in some examples.

Holographic display driver 54 receives Computer Generated Hologram (CGH) data from the program 52 along with scene energy metadata. For example, the CGH data may be sent over an image bus, such as one according to the DisplayPort, High-Definition Multimedia Interface (HDMI), Thunderbolt or USB standards. The scene energy metadata may be encoded as separate data associated with the CGH data and included in the data stream sent over the image bus along with the CGH data. In other examples, the scene energy metadata may be encoded in the image data itself and extracted by the holographic display driver prior to display. The scene energy metadata may be encoded into particular pixels of the CGH data in a way which produces little visible change to the reproduced CGH, such as by overwriting the least significant bit of particular pixels. The particular pixels are at predetermined positions and may be distributed over the frame area and/or located at a periphery of the frame to further reduce any visible change on the image when displayed.

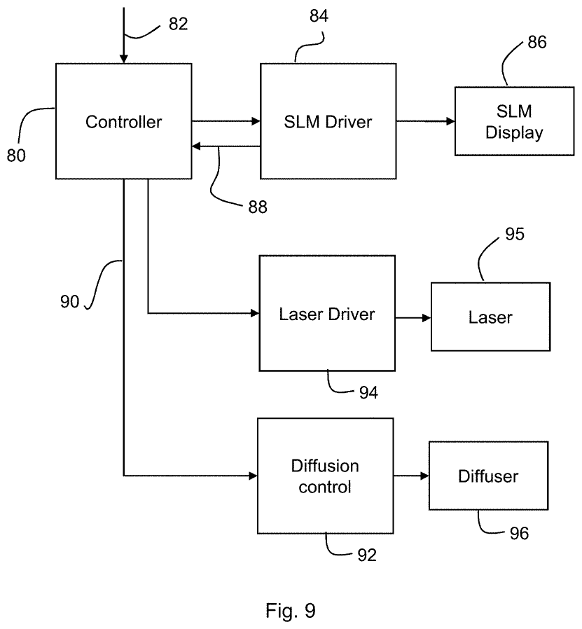

Referring now to FIG. 9, another example of hardware control to synchronize the display of CGH images with appropriate illumination source output power will be described. FIG. 9 depicts a schematic block diagram of an example apparatus to synchronize display of CGH images with illumination power control.

A controller, or processor, 80 receives an input 82 of the CGH data for display, along with scene energy metadata. The controller 80 is configured to separate the scene energy metadata from the CGH data for display and provide the CGH data image to an SLM driver 84 for display on an SLM 86. The SLM driver 84 notifies the controller 80 via a signal 88 once the image is formed on the SLM. Next, the Controller 80 activates a laser 95, or other at least partially coherent light source, via a laser driver 94, to illuminate the SLM. In this way the controller synchronises the displayed CGH image with the correct illumination as defined by the scene energy metadata.

The controller of FIG. 9 is also configured to receive diffusion data indicative of a required diffusion level to apply during display. For example, each CGH image may comprise a plurality of components to be displayed in rapid succession with different levels of diffusion on output, such as described in PCT Application No. PCT/GB2021/051353 filed on 2 Jun. 2021, which is incorporated herein by reference for all purposes. Diffusion has the effect of reducing perceived speckle noise in the image at the expense of also reducing detail. By decomposing images into an image comprising higher spatial frequencies and an image comprising lower spatial frequencies and displaying the image comprising lower spatial frequencies with a greater amount of diffusion the image comprising higher spatial frequencies, noise can be reduced while preserving detail.

The diffusion data may be included as metadata associated with each image. In some examples, the diffusion data is a value corresponding to a relative or absolute level of diffusion to apply. For example, a value of 0 might indicate no diffusion and a value of 1 might indicate that diffusion is active. Other examples of diffusion data are possible.

The controller 80 is configured to separate the diffusion data from the input images and provide the input image to an SLM driver 84 for display on an SLM 86. The SLM driver 84 notifies the controller 80 via a signal 88 once the image is formed on the SLM. Next, the Controller 80 provides a signal 90 to a diffusion control element 92 at the same time as activating a laser 94, or other at least partially coherent light source, to illuminate the SLM.

The diffusion control element 92 is configured to activate and deactivate a diffuser 96 depending on a required speckle reduction in the output image according to the diffusion data. In some embodiments, the diffusion control element 92 is also configured to control a level of diffusion provided by the diffuser. For example, the diffusion control element may control a level of diffusion by selectively activating an ultrasonic mirror and/or adjusting a focus point. Furthermore, if the diffuser is binary, or otherwise has discrete states, the diffusion control element may selectively activate and deactivate the diffuser or switch between states during display of one image according to the desired diffusion amount, such as by using Pulse Width Modulation.

This construction of FIG. 9 allows a single SLM to display CGH images in sequence with control of illumination power and any required diffusion synchronised to the image sequence. Through the use of a hardware control path, accurate and fast synchronisation between the display of the image on the SLM and the appropriate amount of illumination and diffusion may be achieved.

Controller 80 is implemented by a Field Programmable Gate Array (FPGA) in FIG. 9 but is not limited to this. Other examples may use an Application Specific Integrated Circuit (ASIC) or an appropriately programmed processing system.

Some examples may combine the functional blocks depicted in FIG. 9 into a single element. For example, any two or all of the Controller 80, SLM Driver 84, Laser Driver 94 and Diffusion Control 92 may be combined.

High-Definition Multimedia interface (HDMI) is used to supply image data to the controller in FIG. 9 over input interface 82. Other interfaces may be used in other embodiments, including DisplayPort, Thunderbolt, USB and so on.

In some examples, the scene energy metadata and/or the diffusion data is independent of the display hardware and the controller 80 translates the scene energy metadata and the diffusion data to appropriate hardware operation. For example, the diffusion data may be set as predetermined values according to a required level of diffusion and this can be realised using the hardware via the controller 80 and/or the diffusion control 92. Similarly, the scene energy metadata may be independent of an illumination source and determined by the controller 80 based on predetermined characteristics of the laser 94.

Although FIG. 9 depicts a monochrome display with a single laser, other examples adapt the system for the display of colour CGH images. For example, colour CGH images may be formed by the consecutive display of red, green and blue CGH images within a single frame period. The controller 80 may be configured to extract scene energy metadata associated with each of the red, green and blue component images and synchronise the appropriate colour of laser along with an appropriate output power according to the scene energy metadata.

In some examples, the system of FIG. 9 may omit the diffusion control 92 and the diffuser 96. In further examples, additional display features requiring synchronisation may be synchronised using the controller 80, such as control of apertures; control of filters and/or attenuators; control of other despeckle hardware than a diffuser; control of mechanical beam steering elements, such as a movable mirror in the optical path; and sensors, such as a camera or image sensor, head-tracking accelerometers and gyroscopes. Sensor data may be useful when sensor data is useful at a predetermined timing relative to frame timing, such as when stabilising an SLM.

### Illumination Monitoring System

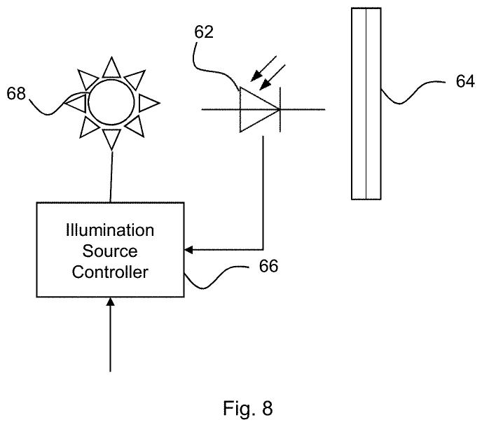

Some examples include an intensity monitoring system, comprising a light intensity sensor mounted within the optical path of the holographic display. The illumination control system can provide feedback control of the output illumination power and/or ensure that the output brightness is within the expected tolerances for the input source frames. An advantage of such feedback control is reduced temperature sensitivity. A block diagram of an example illumination monitoring system is depicted in FIG. 8. Photosensor 62 monitors the brightness from the display 64 and provides feedback to the illumination source controller or driver 66 which drives an illumination source 68.

In one example, the display 64 is a phase modulating LCoS display, the illumination source 68 is an RGB laser source and the photosensor 62 is a photo-transistor mounted inside an optical engine.

The above embodiments are to be understood as illustrative examples of the invention. Further embodiments of the invention are envisaged. For example, although the discussion has focused on source RGB data, the concepts can be applied to any colour space used to represent an image. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for adjusting the apparent brightness of a computer-generated hologram display, the method comprising:
receiving source data representative of a scene to be displayed as a hologram;
determining hologram data to display a computer-generated hologram representing the scene;
determining a scene energy based on the source data and quantised using a scale which is non-linear and which has a closer spacing between values in a mid-section of the scale than between values towards a minimum and a maximum of the scale;
associating the scene energy with the hologram data;
controlling a holographic display according to the hologram data and simultaneously controlling an output power of an illumination source of the holographic display according to the scene energy.

2. The method according to claim 1, wherein the scene energy is normalised to a scale between a predetermined minimum apparent brightness and a predetermined maximum apparent brightness.

3. The method according to claim 1, wherein the scene energy is a sum across all pixels and colours in the source data, the sum comprising a respective weighting for each colour in the source data.

4. The method according to claim 1, wherein the scene energy is represented by sums across all pixels for each colour in the source data, each colour corresponding to a colour of the illumination source.

5. The method according to claim 1, comprising monitoring an emitted intensity of the illumination source and using the emitted intensity for feedback control of the output power of the illumination source.

6. The method according to claim 1, comprising monitoring an emitted intensity of the illumination source and shutting off the illumination source if the emitted intensity exceeds a predetermined threshold.

7. The method according to claim 1, wherein the controlling the output power of the illumination source uses a combination of current modulation and pulse width modulation.

8. The method according to claim 1, comprising receiving data indicative of a temperature of the illumination source, and wherein the controlling the output power of the illumination source is based on the data indicative of the temperature of the illumination source and the scene energy.

9. The method according to claim 1, wherein controlling the holographic display according to the hologram data and simultaneously controlling the output power of an illumination source is synchronised based on a signal received from a modulator of the holographic display.

10. A holographic display system comprising:
an illumination source;
a modulator configured to be illuminated by the illumination source;
an input; and
a controller configured to
receive, via the input, source data representative of a scene to be displayed as a hologram;
determine hologram data to display a computer-generated hologram representing the scene;
determine a scene energy based on the source data and quantised using a scale which is non-linear and has a closer spacing between values in a mid-section of the scale than between values towards a minimum and a maximum of the scale;
associate the scene energy with the hologram data; and
control a holographic display according to the hologram data and simultaneously control an output power of an illumination source of the holographic display according to the scene energy.

11. The holographic display system according to claim 10, wherein the controller is configured to receive data indicative of a temperature of the illumination source, and control the output power of the illumination source based on the data indicative of the temperature of the illumination source and the scene energy.

12. The holographic display system according to claim 10, wherein the controller is configured to monitor an emitted intensity of the illumination source and shut off the illumination source if the emitted intensity exceeds a predetermined threshold.

13. The holographic display system according to claim 10, wherein the scene energy is normalised to a scale between a predetermined minimum apparent brightness and a predetermined maximum apparent brightness.

14. A holographic display apparatus comprising:
an illumination source;
a modulator configured to be illuminated by the illumination source;
an input; and
a controller configured to:
receive, via the input, hologram data and scene energy data associated with the hologram data, the scene energy data quantised using a scale which is non-linear and which has a closer spacing between values in a mid-section of the scale than between values towards a minimum and a maximum of the scale;
operate the modulator to modulate the illumination source, thereby to generate a light field corresponding to a frame or sub-frame of the hologram data; and
control an output optical power of the illumination source incident on the modulator according to scene energy data associated with the frame or sub-frame.

15. The holographic display apparatus according to claim 14, wherein the scene energy is normalised to a scale between a predetermined minimum apparent brightness and a predetermined maximum apparent brightness.

16. The holographic display apparatus according to claim 14, wherein the controller is configured to monitor an emitted intensity of the illumination source and use the emitted intensity for feedback control of the output power of the illumination source.

17. The holographic display apparatus according to claim 14, wherein the controller is configured to monitor an emitted intensity of the illumination source and shut off the illumination source if the emitted intensity exceeds a predetermined threshold.

18. The holographic display apparatus according to claim 14, wherein the controller is configured to control an output power of the illumination source using a combination of current modulation and pulse width modulation.

19. The holographic display apparatus according to claim 14, wherein the controller is configured to receive data indicative of a temperature of the illumination source, and wherein the controlling the output power of the illumination source is based on the data indicative of the temperature of the illumination source and the scene energy.

20. The holographic display apparatus according to claim 14, wherein the control of the output power is synchronised based on a signal received from the modulator.
